(19) United States
(12) Patent Application Publication
(10) Pub. No.: US 2026/0100354 A1
(43) Pub. Date: Apr. 9, 2026

(54) ELECTRODE FOR RECHARGEABLE BATTERY AND ELECTRODE ASSEMBLY INCLUDING THE SAME

(71) Applicant: SAMSUNG SDI CO., LTD., Yongin-si (KR)

(72) Inventors: Hyunho CHO, Yongin-si (KR); Byounghwi LIM, Yongin-si (KR); Soongji BOO, Yongin-si (KR)

(21) Appl. No.: 19/339,142

(22) Filed: Sep. 24, 2025

(30) Foreign Application Priority Data
Oct. 8, 2024 (KR) 10-2024-0137045

(51) Int. Cl. H01M 4/36; H01M 4/02; H01M 10/04

(52) U.S. Cl. CPC H01M 4/366; H01M 10/0431; H01M 2004/021

(57) ABSTRACT

An embodiment of the present disclosure provides a rechargeable battery electrode, including a band-shaped substrate that extends in a direction from a first side to a second side, a front active material layer on a first surface of the substrate, and a rear active material layer on a second surface of the substrate, wherein a thickness of the front active material layer gradually decreases from the first side to the second side, and a thickness of the rear active material layer gradually increases from the first side to the second side.

### CROSS-REFERENCE TO RELATED APPLICATION

The present application claims priority to and the benefit of Korean Patent Application No. 10-2024-0137045, filed on Oct. 8, 2024, in the Korean Intellectual Property Office, the entire content of which is hereby incorporated by reference.

### BACKGROUND

### 1. Field

Embodiments of the present disclosure relate to a rechargeable battery electrode and an electrode assembly including the same.

### 2. Description of the Related Art

Recently, with the rapid spread of electronic devices that use batteries, such as mobile phones, laptop computers, and electric vehicles, a demand for or interest in small, lightweight, and relatively high-capacity rechargeable batteries is rapidly increasing.

For example, lithium rechargeable batteries are attracting attention as a power source for portable devices because they are lightweight and have high energy density. Accordingly, research and development to improve performance of lithium rechargeable batteries is actively being conducted.

These rechargeable batteries may be formed by winding long electrodes or by stacking sheet shapes to form an electrode assembly, and an electrode assembly may be included in a square case, a pouch-shaped case, or a cylindrical case as needed or desired.

Electrodes may be manufactured by applying an active material layer on a substrate, and an active material layer exhibits differences in capacity depending on a thickness thereof.

Among these, for example, a cylindrical electrode assembly, an electrode assembly may be formed by repeatedly winding, so an uneven reaction may occur due to different circumferences from a center thereof to a periphery of the electrode assembly.

In this way, if a ratio of the positive and negative electrodes is different, a facing state may become unstable, which may cause a decrease in performance of the rechargeable battery, such as lithium precipitation during charging, and may also cause safety problems.

If (e.g., when) a reaction between the positive and negative electrodes is uneven, there is a problem that a lifespan of the rechargeable battery is reduced due to phenomena such as partial overcharge or overvoltage.

The above-described information disclosed in the background technology of this disclosure is only for improving understanding of the background of the present disclosure, and therefore, may include information that does not constitute prior art.

### SUMMARY

Embodiments of the present disclosure provides an electrode and an electrode assembly, capable of minimizing or reducing phenomena such as lithium precipitation due to an imbalance in an aspect ratio.

An embodiment of the present disclosure provides a rechargeable battery electrode, including a band-shaped substrate that extends in a direction from a first side to a second side, a front active material layer on a first surface of the substrate, and a rear active material layer on a second surface of the substrate, wherein a thickness of the front active material layer gradually decreases from the first side to the second side, and a thickness of the rear active material layer gradually increases from the first side to the second side.

A sum of the thickness of the front active material layer provided at the first side and the thickness of the rear active material layer provided at the first side may be equal to a sum of the thickness of the front active material layer provided at the second side and the thickness of the rear active material layer provided at the second side.

A thickness of a first end of the front active material layer may be 1.2 times thicker than a thickness of a second end of the front active material layer.

A thickness of a second end of the rear active material layer may be 1.2 times thicker than a thickness of a first end of the rear active material layer.

An embodiment of the present disclosure provides a wound electrode assembly including a positive electrode, a separator, and a negative electrode, wherein the positive electrode includes a substrate, a front active material layer on a first surface of the substrate, and a rear active material layer on a second surface of the substrate,
the negative electrode includes a substrate, a front active material layer on a first surface of the substrate, and a rear active material layer on a second surface of the substrate, and
thicknesses of the front active material layer and the rear active material layer gradually change from a center to an edge of the electrode assembly in the positive and negative electrodes.

The thickness of the rear active material layer of the positive electrode may increase from the center to the edge of the electrode assembly, and the thickness of the front active material layer of the negative electrode that faces the rear active material layer of the positive electrode may decrease from the center to the edge of the electrode assembly.

The thickness of the front active material layer of the positive electrode may decrease from the center to the edge of the electrode assembly.

The thickness of the rear active material layer of the negative electrode may increase from the center to the edge of the electrode assembly.

A sum of the thickness of the front active material layer of the positive electrode and the thickness of the rear active material layer of the positive electrode provided at the center of the electrode assembly may be equal to a sum of the thickness of the front active material layer of the positive electrode and the thickness of the rear active material layer of the positive electrode provided at the edge of the electrode assembly.

An end thickness of the rear active material layer of the positive electrode provided at the edge of the electrode assembly may be 1.2 times thicker than an end thickness of the rear active material layer of the positive electrode provided at the center of the electrode assembly.

An end thickness of the front active material layer of the negative electrode provided at the center of the electrode assembly may be 1.2 times thicker than an end thickness of the front active material layer of the negative electrode provided at the edge of the electrode assembly.

According to embodiments the present disclosure, it may be possible to an electrode and an electrode assembly including the same, capable of maintaining a ratio of positive and negative electrodes uniformly (e.g., substantially uniformly) by gradually varying thicknesses of positive and negative electrodes because even if a difference in the curvature of the positive and negative electrodes occurs, the thicknesses at a center and an edge of the positive and negative electrodes are the same (e.g., substantially the same).

### BRIEF DESCRIPTION OF THE DRAWINGS

The following drawings attached to this specification illustrate example embodiments of the present disclosure, and together with the detailed description of the disclosure described herein, serve to further understand the technical idea of the present disclosure, and thus the present disclosure should not be construed as limited to only the matters depicted in such drawings.

FIG. 1 illustrates a top plan view of a negative electrode for a rechargeable battery according to an embodiment of the present disclosure.

FIG. 2 illustrates a cross-sectional view taken along a line II-II′ of FIG. 1.

FIG. 3 illustrates a cross-sectional view showing a positive electrode and a negative electrode according to another embodiment of the present disclosure.

FIG. 4 illustrates a schematic perspective view of a rechargeable battery according to an embodiment of the present disclosure.

FIG. 5 illustrates a vertical cross-sectional view of the rechargeable battery illustrated in FIG. 4.

FIG. 6 illustrates a cross-sectional view showing a portion of a horizontal cross-sectional view of an electrode assembly included in the rechargeable battery of FIG. 4.

FIG. 7 illustrates a perspective view of a rechargeable battery according to another embodiment of the present disclosure.

FIG. 8 illustrates a cross-sectional view of the rechargeable battery illustrated in FIG. 7.

### DETAILED DESCRIPTION

Hereinafter, embodiments of the present disclosure will be described in more detail with reference to the accompanying drawings. Prior to this, terms and words used in this specification and claims should not be construed as limited to their usual or dictionary meanings, and based on the principle that the inventor can act as his or her own lexicographer and suitably or appropriately define the concept or meaning of a term in order to explain his or her disclosure in the best way or any suitable manner desired, it must be interpreted with a meaning and concept consistent with the technical idea of the present disclosure. Because the embodiments described in the specification and the configurations shown in the drawings are merely examples of some embodiments and configurations of the subject matter of the present disclosure, they do not represent all of the technical ideas of the present disclosure, and it should be understood that various suitable equivalents and modified examples, which may replace the embodiments, are possible.

If (e.g., when) used herein, “comprise, include,” and/or “comprising, including” specifies the presence of the mentioned figures, numbers, steps, actions, members, elements and/or groups of these, and does not exclude the presence or addition of one or more other shapes, numbers, operations, members, elements and/or groups.

To facilitate understanding of the subject matter of the disclosure, the attached drawings may not be drawn to actual scale and the dimensions of some components may be exaggerated. Furthermore, the same reference numbers may be assigned to the same components in different embodiments.

Although the first, second, etc. are used to describe various components, it goes without saying that these components are not limited by these terms. These terms are only used to distinguish one component from another component, and unless specifically stated to the contrary, the first component may also be a second component.

Throughout the specification, unless otherwise stated, each component may be singular or plural.

To illustrate the relationship of one element or feature to another element(s) or feature(s) as shown in a drawing, for ease of description, spatially relative terms such as “beneath,” “below,” “lower,” “above,” “upper,” etc. may be used herein. Spatial relative position will be understood to encompass different directions of the device in use or operation in addition to the direction depicted in the figures. For example, if the device in the drawing is turned over, elements described as “below” or “lower” other elements are understood to be “above” or “upper” other elements. Accordingly, the term “down” may encompass both upward and downward directions.

Additionally, if a component is described as “connected to” or “coupled to” another component; the above components may be directly connected or connected to each other, but it should be understood that other components may be “interposed” between each component, or that each component may be “connected,” “combined,” or “connected” through other components.

The terms used in this specification are for describing embodiments of the present disclosure and are not intended to limit the present disclosure.

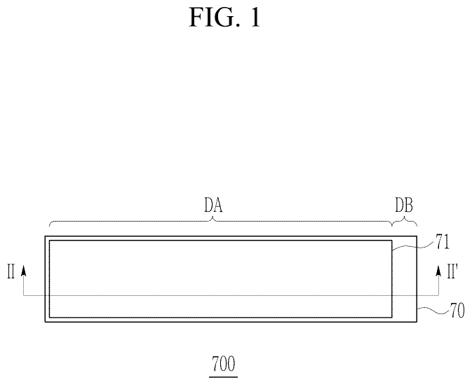

FIG. 1 illustrates a top plan view of a negative electrode for a rechargeable battery according to an embodiment of the present disclosure, and

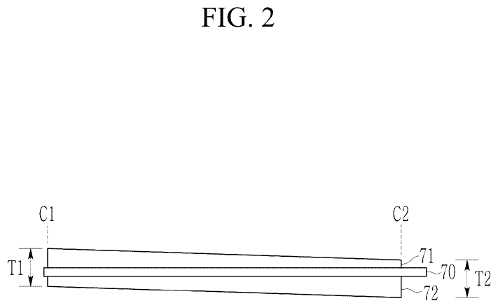

FIG. 2 illustrates a cross-sectional view taken along a line II-II′ of FIG. 1.

As illustrated in FIGS. 1 and 2, an electrode 700 according to an embodiment of the present disclosure may include a substrate 70 and active material layers 71 and 72 on a substrate.

The substrate 70 may be made of a metal thin film such as copper and/or aluminum, and may include an electrode active portion DA and an electrode uncoated portion DB. The substrate 70 may have a long belt shape in a direction, and may be used as an electrode of a would electrode assembly.

The active material layers 71 and 72 may be on the electrode active portion DA, and the electrode uncoated portion DB may be on a first side of the electrode active portion DA, for example, at a tip C1 or an end C2 of the substrate 70, but the present disclosure is not limited thereto, and may be provided in a center of the substrate 70. In embodiments, the electrode uncoated portion DB may be formed to be long along a longitudinal direction (or winding direction) of the electrode active portion DA, and may have a shape that protrudes from the electrode active portion DA to draw out a current (e.g., an electric current) to an outside (e.g., an outside of the rechargeable battery).

The active material layers 71 and 72 may include a front active material layer 71 on a first surface of the substrate 70 and a rear active material layer 72 on a second surface thereof.

Thicknesses of the front active material layer 71 and the rear active material layer 72 may gradually change as they go toward the tip C1 or the end C2 of the substrate, and the thickness changes of the front active material layer 71 and the rear active material layer 72 may be opposite to each other. For example, if (e.g., when) the thickness of the front active material layer 71 decreases from the tip C1 to the end C2, the thickness of the rear active material layer 72 may increase from the tip C1 to the end C2. Conversely, if (e.g., when) the thickness of the front active material layer 71 increases from the tip C1 to the end C2, the thickness of the rear active material layer 72 may decrease from the tip C1 to the end C2.

The thickness of the tip (or a first end) of the front active material layer may be 1.2 times thicker than the thickness of the end (or a second end) of the front active material layer, and the thickness of the end (or a second end) of the rear active material layer may be 1.2 times thicker than the thickness of the tip (or a first end) of the rear active material layer.

In embodiments, a sum T1 of the thickness of the front active material layer 71 and the thickness of the rear active material layer 72 at the tip C1 may be approximately equal to a sum T2 of the thickness of the front active material layer 71 and the thickness of the rear active material layer 72 at the tip C2.

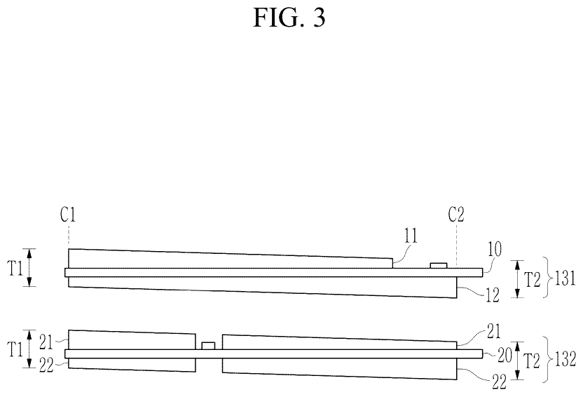

FIG. 3 illustrates a cross-sectional view showing a positive electrode and a negative electrode according to another embodiment of the present disclosure.

As illustrated in FIG. 3, a positive electrode 131 may include a substrate 10, a front active material layer 11 and a rear active material layer 12 on opposite sides of the substrate 10, respectively, and a negative electrode 132 may include a substrate 20, a front active material layer 21 and a rear active material layer 22 on opposite sides of the substrate 20, respectively.

The active material layers 11 and 12 of the positive electrode 131 and the active material layers 21 and 22 of the negative electrode 132 may gradually change in thickness from the tips C1 to the ends C2 of the substrates 10 and 20, as shown in FIG. 1.

Referring to FIG. 3, the thickness changes of the positive electrode 131 and the negative electrode 132 may be the same, but the thickness changes of the active material layers on the facing surfaces may be opposite to each other. For example, the thickness of the front active material layer 11 of the positive electrode 131 may gradually decrease from the tip C1 to the end C2 of the substrate 10, and the thickness of the rear active material layer 12 may gradually increase from the tip C1 to the end C2 of the substrate 10.

In embodiments, the thickness of the front active material layer 21 of the negative electrode 132 may gradually decrease from the tip C1 to the end C2 of the substrate 10, and the thickness of the rear active material layer 22 may gradually increase from the tip C1 to the end C2 of the substrate 10.

In embodiments, the thickness changes of the surfaces where the positive electrode 131 and the negative electrode 132 face each other, for example, the rear active material layer 12 of the positive electrode 131 and the front active material layer 21 of the negative electrode 132, may proceed or extend in opposite directions. For example, the thickness of the rear active material layer 12 of the positive electrode 131 may gradually increase from the tip C1 of the substrate 10 to the end C2, and the thickness of the front active material layer 21 of the negative electrode 132 may gradually decrease from the tip C1 of the substrate 20 to the end C2.

In embodiments, the sum T1 of the active material layers provided at the tips C1 of the substrates 10 and 20 is almost the same as the sum T2 of the active material layers provided at the ends C2 of the substrates 10 and 20.

If (e.g., when) the rechargeable lithium battery is charged, lithium ions are discharged from the positive electrode and inserted into the negative electrode, and in embodiments, if (e.g., when) a site in the negative electrode which can receive the lithium ions from the positive electrode is small, a problem such as lithium precipitation occurs. This problem is caused by loading level (L/L) variations of positive/negative electrodes and an increase in resistance (e.g., electrical resistance) during the reaction.

Accordingly, the electrode assembly 10 is formed such that the negative electrode capacity is larger than the positive electrode capacity, and the N/P ratio, which is a numerical value thereof, has a value of 1.0 to 1.2 in a general rechargeable lithium battery. In the electrode assembly, which is formed by being repeatedly wound like a cylindrical battery, an area A (e.g., N/P=1.05) in which the negative electrode capacity is relatively slightly larger than the positive electrode capacity and an area B (e.g., N/P=1.10) in which the negative electrode capacity is relatively significantly larger than the positive electrode capacity may exist.

This is because the cylindrical electrode assembly is repeatedly wound and formed, so circumferences of the negative and positive electrodes are different, and thus, in embodiments of the present disclosure, the thickness of the active material layer may gradually change from a center to an edge of the cylindrical electrode assembly.

The thickness of the rear active material layer 12 of the positive electrode may become thicker from the center to the edge of the electrode assembly, and the thickness of the front active material layer 21 of the negative electrode facing the rear active material layer 12 of the positive electrode may become thinner from the center to the edge of the electrode assembly.

An end thickness of the rear active material layer 12 of the positive electrode provided at the edge of the electrode assembly may be 1.2 times thicker than an end thickness of the rear active material layer 12 of the positive electrode provided at the center of the electrode assembly, and an end thickness of the front active material layer 21 of the negative electrode provided at the center of the electrode assembly may be 1.2 times thicker than an end thickness of the front active material layer 21 of the negative electrode provided at the edge of the electrode assembly.

In embodiments, as the thicknesses of the positive and negative electrodes are gradually suitably varied, even if (e.g., when) a difference in the curvature of the positive and negative electrodes occurs, thicknesses at the center and edge of the positive and negative electrodes may be the same (e.g., substantially the same), so a ratio of the positive and negative electrodes may be maintained uniformly (e.g., substantially uniformly).

In embodiments, the thickness of the active material layer may be increased or decreased to a thickness capable of preserving a capacity difference at the facing surfaces of the positive and negative electrodes as a radius of curvature increases, so the electrode assembly may have a same overall aspect ratio from the center to the edge.

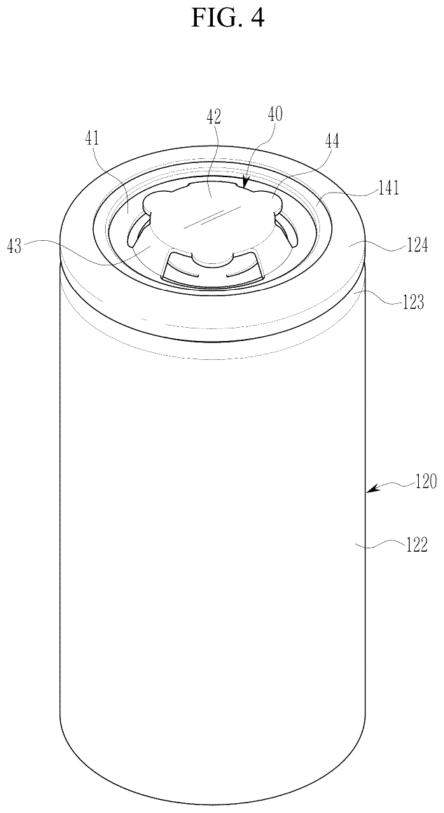

FIG. 4 illustrates a schematic perspective view of a rechargeable battery according to an embodiment of the present disclosure,

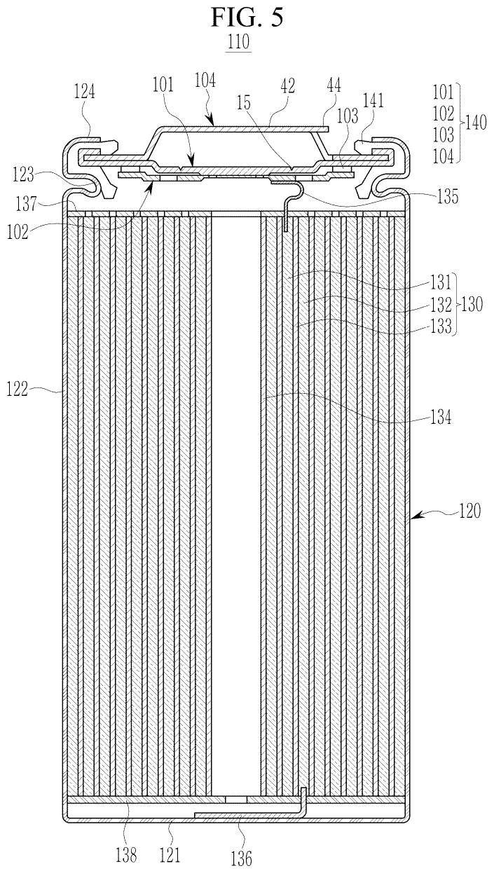

FIG. 5 illustrates a vertical cross-sectional view of the rechargeable battery illustrated in FIG. 4, and

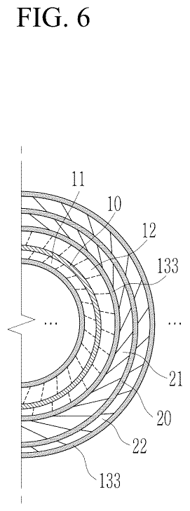

FIG. 6 illustrates a cross-sectional view showing a portion of a horizontal cross-sectional view of an electrode assembly included in the rechargeable battery of FIG. 4.

As illustrated in FIGS. 4 and 5, the rechargeable battery 110 according to an embodiment of the present disclosure may include a case 120, an electrode assembly 130 accommodated inside the case 120, and a cap assembly 140 assembled into an opening of the case 120 to seal the case 120. The cap assembly 140 may include a safety vent 101 that prevents explosion of the rechargeable battery 110 (or reduces a likelihood, degree, or occurrence of such explosions) and a cap up 104 that covers the safety vent 101.

The electrode assembly 130 includes a positive electrode 131, a separator 133, and a negative electrode 132 which are sequentially stacked. The electrode assembly 130 may be a cylindrical jelly roll that is wound after stacking the positive electrode 131, the separator 133, and the negative electrode 132.

The positive electrode 131 may include a positive electrode substrate, an electrode active portion in which an active material layer is on the positive electrode substrate, and an electrode uncoated portion in which the substrate is exposed as is because the active material layer is not formed. The positive electrode substrate may be formed of a thin conductive metal plate (e.g., a thin electrically conductive metal plate) and used as a current collector, and it may include, e.g., aluminum. A positive electrode tab 135 may be connected to the electrode uncoated portion, and the positive electrode tab 135 may be made of a material similar to that of the substrate, e.g., aluminum.

The positive electrode active material layer may be on one or opposite sides of the positive electrode substrate. The positive electrode active material layer may include a positive electrode active material, and may further include a binder and/or a conductive material (e.g., an electrically conductive material). A content (e.g., amount) of the positive active material in the positive electrode active material layer may be 90 wt % to 99.5 wt % with respect to 100 wt % of the positive electrode active material layer, and contents of the binder and the conductive material may be 0.5 wt % to 5 wt % with respect to 100 wt % of the positive electrode active material layer.

### Positive Electrode Active Material

As the positive electrode active material, a compound capable of reversible intercalation and deintercalation of lithium (lithiated intercalation compound) may be used. For example, at least one selected from among composite oxides of lithium and a metal selected from cobalt, manganese, nickel, and a combination thereof may be used.

The above composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any of the following formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c} D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L1_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂ (PO₄)₃ (0≤f≤2); LiₐFePO₄ (0.90≤a≤1.8).

In the above formulas, A indicates Ni, Co, Mn, or a combination thereof; X indicates Al, Ni, Co, Mn, Cr, Fe, Mg, Sr, V, a rare earth element, or a combination thereof; D indicates O, F, S, P, or a combination thereof; G indicates Al, Cr, Mn, Fe, Mg, La, Ce, Sr, V, or a combination thereof; and L1 indicates Mn, Al, or a combination thereof.

As an example, the positive electrode active material may be a high nickel-based positive electrode active material having a nickel content of 80 mol % or more, 85 mol % or more, 90 mol % or more, 91 mol % or more, or 94 mol % or more and 99 mol % or less with respect to 100 mol % of metals other than lithium in a lithium transition metal composite oxide. High-nickel-based positive electrode active materials may achieve high capacity, and may be applied to high-capacity, high-density lithium rechargeable batteries.

### Binder

The binder serves to ensure that particles of the positive electrode active material adhere to each other and also to adhere the positive electrode active material to the current collector. Representative examples of binders include polymers including polyvinyl alcohol, carboxymethylcellulose, hydroxypropylcellulose, diacetylcellulose, polyvinyl chloride, carboxylated polyvinyl chloride, polyvinyl fluoride, ethylene oxide, polyvinylpyrrolidone, polyurethane, polytetrafluoroethylene, polyvinylidene fluoride, polyethylene, polypropylene, styrene butadiene rubber, acrylated styrene butadiene rubber, epoxy resin, nylon, and/or the like, but the present disclosure is not limited thereto.

### Conductive Material

The conductive material is used to impart conductivity (e.g., electrical conductivity) to the electrode, and any suitable electronic conductive material that does not cause a chemical change in the battery (e.g., does not cause an undesirable chemical change in the rechargeable battery) may be used. Examples of the conductive material may include, e.g., a carbon-based material such as natural graphite, artificial graphite, carbon black, acetylene black, Ketjen black, carbon fiber, and carbon nanotubes; a metallic substance including copper, nickel, aluminum, silver, and/or the like and in the form of metal powder and/or metal fiber; a conductive polymer (e.g., an electrically conductive polymer) such as polyphenylene derivative; or a mixture thereof.

As shown in FIGS. 1 to 3, the thickness of the active material layer of the positive electrode may gradually change from the center to the edge of the electrode assembly 130.

Referring to FIG. 6, the positive electrode 131 may include a substrate 10, a front active material layer 11 on the substrate, and a rear active material layer 12, and the front active material layer 11 may gradually increase in thickness from the center to the edge of the electrode assembly, and the rear active material layer 12 may gradually decrease in thickness from the center to the edge of the electrode assembly.

An end thickness of the rear active material layer 12 of the positive electrode provided at the edge of the electrode assembly may be 1.2 times thicker than an end thickness of the rear active material layer 12 of the positive electrode provided at the center of the electrode assembly, and an end thickness of the front active material layer 11 of the positive electrode positioned at the center may be 1.2 times thicker than an end thickness of the front active material layer 11 of the positive electrode provided at the edge thereof.

Again, referring to FIGS. 4 and 5, the negative electrode 132 may include an electrode active portion including a negative electrode substrate, an active material layer on the negative electrode substrate, and an electrode uncoated portion in which the substrate is exposed as is because the active material layer is not formed. The negative electrode substrate may be formed of a thin conductive metal plate (e.g., a thin electrically conductive metal plate) and used as a current collector, and may be, e.g., copper. A negative tab 136 may be connected to the electrode uncoated portion.

The negative electrode active material layer may be on one or opposite sides of the substrate. A content (e.g., amount) of the negative electrode active material in the negative electrode active material layer may be 95 wt % to 99 wt % based on a total weight of the negative electrode active material layer.

The negative electrode active material may include a binder, and may optionally further include a conductive material (e.g., an electrically conductive material). A content (e.g., amount) of the binder in the negative electrode active material may be 1 wt % to 5 wt % based on a total weight of the negative electrode active material. In embodiments, if (e.g., when) the conductive material is further included, the negative electrode active material may be used in an amount of 90 wt % to 98 wt %, the binder may be used in an amount of 1 wt % to 5 wt %, and the conductive material may be used in an amount of 1 wt % to 5 wt %.

### Negative Electrode Active Material

The negative electrode active material includes a material capable of reversibly intercalating/deintercalating lithium ions, lithium metal, an alloy of lithium metal, a material capable of doping and dedoping lithium, and/or a transition metal oxide.

The material capable of reversibly intercalating/deintercalating lithium ions may include a carbon-based negative electrode active material, e.g., crystalline carbon, amorphous carbon, or a combination thereof. Examples of the crystalline carbon may include graphite such as amorphous, plate-shaped, flake-shaped, spherical and/or fibrous natural graphite and/or artificial graphite, and examples of the amorphous carbon may include soft carbon and/or hard carbon, mesophase pitch carbide, and calcined coke.

As the alloy of the lithium metal, an alloy of lithium with a metal selected from Na, K, Rb, Cs, Fr, Be, Mg, Ca, Sr, Si, Sb, Pb, In, Zn, Ba, Ra, Ge, Al and Sn may be used.

A Si-based negative electrode active material and/or a Sn-based negative electrode active material may be used as a material capable of doping and dedoping lithium. The Si-based negative electrode active material may be silicon, a silicon-carbon composite, a silicon oxide (SiOₓ, 0<x≤2), a Si-Q alloy (wherein Q is selected from an alkali metal, an alkaline earth metal, a Group 13 element, a Group 14 element (excluding Si), a Group 15 element, a Group 16 element, a transition metal, a rare earth element, and a combination thereof), or a combination thereof. The Sn-based negative electrode active material may include Sn, SnO2, an Sn-based alloy, or a combination thereof.

The silicon-carbon composite may be a composite of silicon and amorphous carbon. According to an embodiment, the silicon-carbon composite may be in the form of silicon particles and amorphous carbon coated on surfaces of the silicon particles. For example, it may include a secondary particle (core) in which silicon primary particles are assembled and an amorphous carbon coating layer (shell) on a surface of the secondary particle. The amorphous carbon may also be between the silicon primary particles, and for example, the silicon primary particles may be coated with amorphous carbon. The secondary particles may be dispersed in an amorphous carbon matrix.

The silicon-carbon composite may further include crystalline carbon. For example, the silicon-carbon composite may include a core containing crystalline carbon and silicon particles and an amorphous carbon coating layer on a surface of the core.

The Si-based negative electrode active material and/or Sn-based negative electrode active material may be used by mixing with a carbon-based negative electrode active material.

### Binder

The binder serves to ensure that particles of the negative electrode active material adhere to each other and also to adhere the negative electrode active material to the current collector. The binder may be a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, poly amide-imide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, fluoroelastomer, polyethylene oxide, polyvinylpyrrolidone, polyepichlorohydrin, polyphosphazene, poly(meth)acrylonitrile, ethylene propylene diene copolymer, polyvinylpyridine, chlorosulfonated polyethylene, latex, polyester resin, (meth)acrylic resin, phenol resin, epoxy resin, polyvinyl alcohol, and a combination thereof.

If (e.g., when) an aqueous binder is used as the negative electrode binder, it may further contain a cellulose-based compound capable of imparting or increasing viscosity. As the cellulose-based compound, carboxymethyl cellulose, hydroxypropylmethyl cellulose, methyl cellulose, an alkali metal salt thereof, and/or the like may be used in combination. As the alkali metal, Na, K, and/or Li may be used.

The dry binder may be a polymer material capable of being fiberized, and may be, e.g., polytetrafluoroethylene, polyvinylidene fluoride, polyvinylidene fluoride-hexafluoropropylene copolymer, polyethylene oxide, or a combination thereof.

### Conductive Material

The conductive material is used to impart or increase conductivity (e.g., electrical conductivity) to the electrode, and any suitable electronically conductive material that does not cause a chemical change in the battery (e.g., does not cause an undesirable chemical change in the rechargeable battery) may be used. Examples thereof may include, e.g., a carbon-based material such as natural graphite, artificial graphite, carbon black, acetylene black, Ketjen black, carbon fiber, and carbon nanotubes; a metallic substance including copper, nickel, aluminum, silver, etc. and in the form of metal powder and/or metal fiber; a conductive polymer (e.g., an electrically conductive polymer) such as polyphenylene derivative; or a mixture thereof.

As shown in FIGS. 1 to 3, the thickness of the active material layer of the negative electrode 132 may gradually change, and may gradually change from the center to the edge of the electrode assembly 130.

Referring to FIG. 6, the negative electrode 132 may include a substrate (20), a front active material layer 21 on the substrate 20, and a rear active material layer 22. The front active material layer 21 may face the rear active material layer of the positive electrode, and an end thickness of the front active material layer 21 of the negative electrode provided at the center of the electrode assembly may be 1.2 times thicker than an end thickness of the front active material layer 21 of the negative electrode provided at the edge of the electrode assembly.

Again, referring to FIGS. 4 and 5, a separator 133 may be between the first electrode 131 and the second electrode 132 and insulate (e.g., electrically insulate) them therebetween, the separator 133 may be a multilayer film made of polyethylene, polypropylene, polyvinylidene fluoride, or two or more layers thereof, and a mixed multilayer film such as a polyethylene/polypropylene two-layer separator, a polyethylene/polypropylene/polyethylene three-layer separator, or a polypropylene/polyethylene/polypropylene three-layer separator may be used.

The electrode assembly 130 may be wound around a center pin 134, the center pin 134 may be provided at the center of the electrode assembly 130, and may be provided parallel (e.g., substantially parallel) to a direction in which the electrode assembly 130 is inserted into the case 120.

The center pin 134 may be designed to maintain a shape that is minimally deformed or close to a shape before deformation if (e.g., when) subjected to a full-surface compressive load and/or local impact load applied from an outside of the rechargeable battery, and may be in a form of a hollow circular pipe. In embodiments, the center pin 134 may serve as a passage for gas generated internally. The center pin 134 may be omitted as required or desired.

The center pin 134 may be formed of a material having a set or certain rigidity, such as a conductive metal (e.g., an electrically conductive metal) such as steel, a steel alloy, aluminum, and/or an aluminum alloy, in order to be minimally deformed by external impact. In embodiments, the center pin 134 may have conductivity (e.g., electrical conductivity), a first insulating plate 137 may be between the cap assembly 140 and an upper end of the center pin 134 such that opposite ends of the center pin 134 may remain insulated (e.g., electrically insulated), and a second insulating plate 138 may be between a bottom portion 121 of the case 120 and a lower end of the center pin 134.

The first insulating plate 137 may be formed with a through hole that extends through an interior of the center pin 134, a through hole that pass through the positive electrode tab 135, and a plurality of through holes through which electrolyte flows. A through hole in communication with the interior of the center pin 134 and a through hole through which the negative tab 136 extends may be formed in the second insulating plate 138.

The case 120 may have one side open such that the electrode assembly 130 may be inserted together with an electrolyte, and may be formed to have approximately a same shape as that of the electrode assembly 130. It may include a circular bottom portion and a cylindrical side portion extending upward from the bottom portion by a set or certain length.

During an assembly process of the rechargeable battery, an upper portion of the cylindrical case may be opened. Accordingly, during the assembly process of the rechargeable battery, the electrode assembly may be inserted into a cylindrical case, and then the electrolyte may be injected into the cylindrical case. The case 120 may be made of steel, a steel alloy, aluminum, an aluminum alloy, and/or the like.

The electrolyte may allow lithium ions, which are produced by an electrochemical reaction at the positive and negative electrodes inside the battery, to move. The electrolyte may be formed of an organic solvent such as EC, PC, DEC, EMC, and/or DMC, and a lithium salt such as LiPF₆ and LiBF₄. The electrolyte may be liquid, solid, or gelled.

A beading portion 123 and a crimping portion 124 may be on a side portion 122 of the case 120.

The beading portion 123 may be a portion that is concavely deformed toward the inside of the case 120, and the crimping portion 124 may be a portion that is deformed such that an edge of the side portion 122 is bent toward the inside. The electrode assembly 130 may be restrained from moving by the beading portion 123, and the cap assembly 140 may be fixed to the case 120 by the crimping portion 124.

The cap assembly 140 may include a safety vent 101 that prevents explosion of the rechargeable battery 110 (or reduces a likelihood, degree, or occurrence of such an explosion) and a cap up 104 that covers the safety vent 101.

The cap assembly 140 may include a safety vent 101 having a notch groove 15, a cap down 102 on a first side (lower side) of the safety vent 101 facing the electrode assembly 130, a ring-shaped insulating portion 103 between the safety vent 101 and the cap down 102, and a cap up 104 on a first side (upper side) of the safety vent 101 opposite to the cap down 102. The safety vent 10 may be referred to as a current interruptive device (CID).

A central portion of the safety vent 10 may be thicker than a peripheral portion around (e.g., surrounding) the central portion, and a notch groove 15 may be provided at the peripheral portion.

A thickness of the central portion of the cap down 102 may be smaller than a thickness of the peripheral portion around (e.g., surrounding) the central portion, and at least one opening may be formed in the central portion and the peripheral portion.

The central portion of the safety vent 101 and the central portion of the cap down 102 may be joined as one piece by a method such as welding, and the safety vent 101 and the cap down 102 may be provided at a distance from each other in a remaining portion excluding the central portion.

The insulating portion 103 may be around (e.g., surround) the center of the safety vent 101 and the cap down 102, and may be between the safety vent 101 and the cap down 102. The insulating portion 103 may be integrally joined to the safety vent 101 and the cap down 102 by a method such as fusion.

The positive tab 135 of the electrode assembly 130 may be fixed to a first side (or lower side) of the cap down 102, and the cap down 102, the safety vent 101, and the cap up 104 may be charged with the positive electrode. The positive tab 135 may be bent such that a first side of the cap down 102 faces it to increase a contact area with the cap down 102.

The cap-up 104 may protrude outward so as to function as a positive terminal that contacts an external device and allows current to flow to an outside, and may have a flat surface.

The negative tab 136 may be connected to the electrode uncoated portion of the negative electrode so as to protrude in an opposite direction to the positive tab 125, and may be fixed by welding to a lower bottom surface of the case 120. Accordingly, the case 120 may be charged negatively, and the bottom portion 121 of the case 120 may function as a negative terminal.

The cap assembly 140 may be joined to the side portion 122 of the case 120 via an insulating gasket 141. The insulating gasket 141 may be around (e.g., surround) an edge of the safety vent 101 and the cap-up 104, and the insulating gasket 141 may be compressed between the beading portion 123 and the crimping portion 124 of the case 120.

During use of the rechargeable battery 110, gas may be generated inside the case 120 for various reasons, and an internal pressure of the rechargeable battery 110 may increase due to the gas.

If (e.g., when) gas is generated, pressure may be continuously applied to the safety vent 101 through an opening of the cap down 102, and at a set or certain pressure, the safety vent 101 may be deformed toward the outside (or upper side) of the cap assembly 140, so the safety vent 101 and the cap down 102 may be separated from each other. In embodiments, the central portion of the cap down 102 may be broken from the peripheral portion and rises together with the safety vent 101 while attached to the central portion of the safety vent 101.

The current flow (e.g., electric current flow) may be blocked by separation of the safety vent 101 and the cap down 102, and then, if (e.g., when) the pressure continues to rise, the safety vent 101 may break around the notch groove 15 and internal gas is discharged. The internal gas may be discharged to the outside of the rechargeable battery 110 through an exhaust port formed in the cap-up 104.

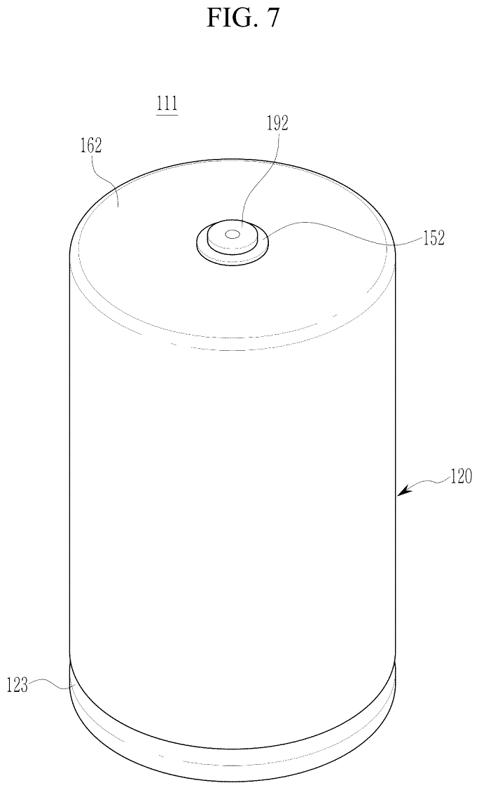

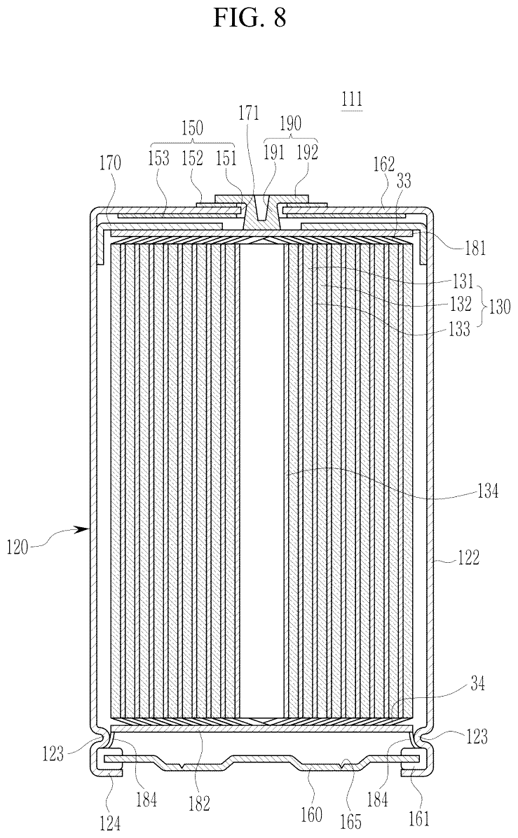

FIG. 7 illustrates a perspective view of a rechargeable battery according to another embodiment of the present disclosure, and FIG. 8 illustrates a cross-sectional view of the rechargeable battery illustrated in FIG. 7.

Most of FIG. 7 and FIG. 8 are identical to FIG. 1 to FIG. 6, so differences will be specifically described.

Referring to FIGS. 7 and 8, the rechargeable battery 111 may include an electrode assembly 130, a case 120 that accommodates the electrode assembly 130 therein, a rivet terminal 190 installed in a terminal hole 171 of the case 120, and an insulator 150 between the case 120 and the rivet terminal 190.

The rechargeable battery 111 may include a cap plate 160 coupled to an opening of the case 120 to seal the case 120.

The electrode assembly 130 may include a positive electrode 131, a negative electrode 132, and a separator 133, and may be accommodated inside the case 120 together with an electrolyte. Each of the positive electrode, the negative electrode, and the separator may be configured in a long strip shape, and may be wound in a circular shape around the center pin 134.

As shown in FIGS. 1 to 3, thicknesses of the positive and negative electrodes may be gradually changed, and thicknesses of the active material layer may gradually change from a center to an edge of the electrode assembly 130.

The positive electrode 131 may include a substrate 10, a front active material layer 11 on the substrate 10, and a rear active material layer 12, and the front active material layer 11 may gradually increase in thickness from the center to the edge of the electrode assembly, and the rear active material layer 12 may gradually decrease in thickness from the center to the edge of the electrode assembly.

The negative electrode 132 may include a substrate 20, a front active material layer 21 on the substrate 20, and a rear active material layer 22, and the front active material layer 21 may gradually increase in thickness from the center to the edge of the electrode assembly 130, and the rear active material layer 22 may gradually decrease in thickness from the center to the edge of the electrode assembly 130.

The positive and negative electrodes may respectively include electrode active portions 31 and 32 each including a substrate, an active material layer on the substrate, and electrode uncoated portions 33 and 34 each in which the substrate is exposed and does not include an active material layer. The electrode uncoated regions 33 and 34 may be on opposite sides centered on the electrode active regions 31 and 32, and may be formed long along a wound direction of the positive and negative electrodes.

The electrode uncoated portions 33 and 34 may be bent toward the center pin 134, and the electrode uncoated portions that overlap while being wound may be electrically connected by welding, and/or the like. The electrode uncoated regions 33 and 34 may be formed with a notch to facilitate bending.

The case 120 may be opened at a first side (or lower side) to allow the electrode assembly 130 and a first current collector 181 and a second current collector 182 to enter. The case 120 may include a top portion 162 at a second side thereof and a side portion 122 connected to an edge of the top portion 162. The top portion 162 may be referred to as a bottom portion if (e.g., when) top and bottom of the rechargeable battery are switched.

A terminal hole 171 may be provided in a center of the top portion 162, and a rivet terminal 190 may be installed in the terminal hole 171 via an insulator 150. The rivet terminal 190 may be coupled to the first collector plate 181, and the rivet terminal 190 may be charged with a same polarity as the positive electrode by the first collector plate 181 which is electrically connected to the electrode uncoated portion 33 of the positive electrode, thereby functioning as a positive terminal.

The rivet terminal 190 may be inserted into the terminal hole 171 while being around (e.g., surrounded by) the insulator 150. The insulator 150 may insulate (e.g., electrically insulate) the rivet terminal 190 and the top portion 162 of the case 120, and seal the terminal hole 171 to prevent or reduce leakage of an electrolyte. An insulating member 170 may be additionally on a first surface of the first collector plate 181 facing the top portion 162.

The cap plate 160 may be provided at a first side (or lower side) of the second collector plate 182, and may be coupled to a lower end portion of the side portion 122 via an insulating gasket 161. A notch groove 165 may be on an inner surface of the cap plate 160. The notch groove 165 may be thinner than other portions and may have an arc shape in a plan view (e.g., if (e.g., when) viewing the object from above).

If (e.g., when) an internal pressure of the rechargeable battery increases, the cap plate 160 may break around the notch groove 165 to release internal gas.

The beading portion 123 and the crimping portion 124 may be on the side portion 122. The beading portion 123 may be a portion in which a portion of the side portion 122 is concavely deformed toward an inside of the case 120, and the crimping portion 124 may be a portion in which an end of the side portion 122 is vertically bent toward an inside of the side portion 122.

The electrode assembly 130 may be restrained from moving inside the case 120 by the beading portion 123, and edges of the insulating gasket 161 and the cap plate 160 may be pressed between the beading portion 123 and the crimping portion 124.

In embodiments, the second collector plate 182 may include a conductive portion 184 that is in close contact with an inner surface of the side portion 122 of the case 120. A plurality of conductive portions 184 may be provided along an edge of the second collector plate 182. The case 120 may be charged with a same polarity as that of the negative electrode by the second collector plate 182 and the conductive portion 184 electrically connected to the electrode uncoated portion 34 to function as a negative terminal.

The rivet terminal 190 may include a pillar portion 191 that extends through the terminal hole 171 and a head portion 192 connected to the pillar portion 191 and on the outside (upper side) of the top portion 162. The pillar portion 191 and the head portion 192 may be manufactured as a single piece, and the pillar portion 191 may be inserted from an outside to an inside of the top portion 162 and fitted into the terminal hole 171.

The rivet terminal 190 is charged as a positive electrode, and the case 120 is charged as a negative electrode, so they have opposite polarities and must be insulated (e.g., electrically insulated) from each other. Accordingly, the insulator 150 may be between the rivet terminal 190 and the case 120.

The insulator 150 may be manufactured by dividing it into three pieces corresponding to a middle portion 151, an outer portion 152, and an inner portion 153, and the three pieces may be combined as a single unit during the assembly process of the rechargeable battery. The middle portion 151 may be in contact with the pillar portion 191 and is fitted into the terminal hole 171. The outer portion 152 may be between an outer surface of the head portion 192 and the top portion 162, and may be in close contact with outer surfaces of the head portion 192 and the top portion 162. The inner portion 153 may be in close contact with the inner surface of the top portion 162. The middle portion 151 may be in contact with the outer portion 152 and the inner portion 153, and may be connected as a single piece.

The outer portion 152 and the inner portion 153 may be configured in a disc shape with a hole in a center thereof. The inner portion 153 may have a function of preventing the first collector plate 181 from making direct contact with the case 120.

While the subject matter of this disclosure has been described in connection with what is presently considered to be practical embodiments, it is to be understood that the present disclosure is not limited to the disclosed embodiments, but, on the contrary, is intended to cover various suitable modifications and equivalent arrangements included within the spirit and scope of the appended claims, and equivalents thereof.

Description of Symbols

| | | | |
|---|---|---|---|
| 10, 20, 70: | substrate | 11, 12, 21, | active material |
| | | 22, 71, 721: | layer |
| 33, 34: | electrode uncoated | 101: | safety vent |
| | portion | | |
| 102: | cap down | 103: | insulating portion |
| 104: | cap up | 110, 111: | rechargeable battery |
| 120: | case | 122: | side portion |
| 123: | beading portion | 124: | crimping portion |
| 130: | electrode assembly | 131: | positive electrode |
| 132: | negative electrode | 133: | separator |
| 134: | center pin | 140: | cap assembly |
| 150: | insulator | 160: | cap plate |
| 190: | rivet terminal | 700: | electrode |

What is claimed is:

1. A rechargeable battery electrode comprising:
a band-shaped substrate that extends in a direction from a first side to a second side;
a front active material layer on a first surface of the substrate; and
a rear active material layer on a second surface of the substrate;
wherein a thickness of the front active material layer decreases from the first side to the second side, and
a thickness of the rear active material layer increases from the first side to the second side.

2. The rechargeable battery electrode of claim 1, wherein:
a sum of the thickness of the front active material layer provided at the first side and the thickness of the rear active material layer provided at the first side
is equal to a sum of the thickness of the front active material layer provided at the second side and the thickness of the rear active material layer provided at the second side.

3. The rechargeable battery electrode of claim 1, wherein:
a thickness of a first end of the front active material layer is 1.2 times thicker than a thickness of a second end of the front active material layer.

4. The rechargeable battery electrode of claim 1, wherein:
a thickness of a second end of the rear active material layer is 1.2 times thicker than a thickness of a first end of the rear active material layer.

5. A wound electrode assembly comprising a positive electrode, a separator, and a negative electrode,
wherein the positive electrode comprises a substrate, a front active material layer on a first surface of the substrate, and a rear active material layer on a second surface of the substrate,
the negative electrode comprises a substrate, a front active material layer on a first surface of the substrate, and a rear active material layer on a second surface of the substrate, and
thicknesses of the front active material layer and the rear active material layer gradually change from a center to an edge of the electrode assembly in the positive and negative electrodes.

6. The electrode assembly of claim 5, wherein:
the thickness of the rear active material layer of the positive electrode increases from the center to the edge of the electrode assembly, and
the thickness of the front active material layer of the negative electrode facing the rear active material layer of the positive electrode decreases from the center to the edge of the electrode assembly.

7. The electrode assembly of claim 6, wherein:
the thickness of the front active material layer of the positive electrode decreases from the center to the edge of the electrode assembly.

8. The electrode assembly of claim 6, wherein:
the thickness of the rear active material layer of the negative electrode increases from the center to the edge of the electrode assembly.

9. The electrode assembly of claim 1, wherein:
a sum of the thickness of the front active material layer of the positive electrode and the thickness of the rear active material layer of the positive electrode provided at the center of the electrode assembly
is equal to a sum of the thickness of the front active material layer of the positive electrode and the thickness of the rear active material layer of the positive electrode provided at the edge of the electrode assembly.

10. The electrode assembly of claim 9, wherein:
an end thickness of the rear active material layer of the positive electrode provided at the edge of the electrode assembly is 1.2 times thicker than an end thickness of the rear active material layer of the positive electrode provided at the center of the electrode assembly.

11. The electrode assembly of claim 9, wherein:
an end thickness of the front active material layer of the negative electrode provided at the center of the electrode assembly is 1.2 times thicker than an end thickness of the front active material layer of the negative electrode provided at the edge of the electrode assembly.
